(19) United States
(12) Patent Application Publication
(10) Pub. No.: US 2015/0120417 A1
(43) Pub. Date: Apr. 30, 2015

(54) METHOD FOR PROVIDING FAVORITE STORE MANAGEMENT SERVICE IN ELECTRONIC COMMERCE USING INTERNET AND COMPUTER-READABLE RECORDING MEDIUM HAVING PROGRAM RECORDED THEREON FOR EXECUTING THE METHOD IS RECORDED

(71) Applicant: EBAY KOREA CO., LTD., Gangnam-gu Seoul (KR)

(72) Inventor: Eun Sook Kim, Gangnam-gu Seoul (KR)

(21) Appl. No.: 14/408,261

(22) PCT Filed: Jun. 13, 2013
(86) PCT No.: PCT/KR2013/005244

§ 371 Date: Dec. 15, 2014

(30) Foreign Application Priority Data
Jun. 15, 2012 (KR) 10-2012-0064359

(51) Int. Cl. G06Q 30/06; G06Q 30/02

(52) U.S. Cl. CPC G06Q 30/0641; G06Q 30/0222
USPC 705/14.23; 705/27.1

(57) ABSTRACT

Provided is a method of providing a favorite shop management service in electronic commerce using the Internet for inducing continuous and repeated purchases rather than a one-time purchase by classifying an interest shop, a purchased shop, or an impressive shop as a favorite shop based on the repeated number of purchases or a purchase amount of selling products pre-registered by a seller, and differentially managing the classified favorite shop.

### CROSS-REFERENCE TO RELATED APPLICATION

This application claims priority to and the benefit of Korean Patent Application No. 2012-0064359, filed on Jun. 15, 2012, the disclosure of which is incorporated herein by reference in its entirety.

### BACKGROUND

1. Field of the Invention

The present invention relates to a method of providing a favorite shop management service in electronic commerce using the Internet, and more particularly, to a method of providing a favorite shop management service in electronic commerce using the Internet for inducing continuous and repeated purchases rather than a one-time purchase by classifying an interest shop, a purchased shop representing a shop from which a product is purchased, or an impressive shop as a favorite shop based on the repeated number of purchases or a purchase amount of selling products pre-registered by a seller, and managing the classified favorite shop systematically along with differential rewards, and a computer-readable recording medium recording a program for executing the method.

2. Discussion of Related Art

Recently, electronic commerce in which products are purchased online has grown day by day with the rapid development of the Internet. This electronic commerce is extending to various product areas including household goods, home appliances, electronic products, and the like.

The development of a communication network has contributed to the development of the electronic commerce. Above all, sellers and purchasers may have other advantages that are not obtainable in a traditional commerce system.

That is, because the seller does not need to have a shop or a separate large storage for storing goods, the money of facility investment can be saved and reflected in a product price. In the viewpoint of the purchase, there is an advantage in that it is possible to conveniently do shopping without inconveniently visiting the shop and cheaply purchase goods.

Even in a product purchasing process through the electronic commerce, there is a need for a payment system in which cyber customers can receive various discount rewards according to sales contribution of a shop as in offline commerce.

That is, when the customers repeatedly purchase products of a shop of the same seller, they want to receive a continuous service as well as special rewards from the favorite shop. However, in the electronic commerce of the conventional technology, there is a problem in that it is difficult to systematically manage the favorite shop according to the repeated purchase and only one-time purchase is simply performed without continuous purchase because there are no special rewards from the favorite shop.

### SUMMARY OF THE INVENTION

The present invention is directed to provide a method of providing a favorite shop management service in electronic commerce using the Internet for inducing continuous and repeated purchases rather than a one-time purchase by classifying an interest shop, a purchased shop, or an impressive shop as a favorite shop based on the repeated number of purchases or a purchase amount of selling products pre-registered by a seller, and managing the classified favorite shop systematically along with differential rewards, and a computer-readable recording medium recording a program for executing the method.

According to one aspect of the present invention, there is provided an electronic commerce method of brokering an online transaction between a seller and a purchaser in an online shopping mall through a seller terminal and a purchaser terminal which are connected to a shopping mall server via the internet, including: (a) classifying each shop having selling products as any one of favorite shops including an interest shop, a purchased shop and an impressive shop based on the number of the purchases or the purchase amount specific to each purchaser registered as a member for pre-registered products from the seller terminal through the shopping mall server; (b) selecting any one of the favorite shops including the interest shop, the purchased shop and the impressive shop classified in the step (a) through the purchaser terminal, and registering the selected shop in the shopping mall server; (c) grouping, storing, and managing the favorite shops as the interest shop, the purchased shop and the impressive shop specific to each purchaser registered as the member; and (d) providing a service for displaying a list of selling products along with basic information of the favorite shops registered by the purchaser registered as the member through the shopping mall server on a screen of the purchaser terminal.

Preferably, in the step (a), the shopping mall server may designate a shop as the impressive shop if the purchaser purchases products from the same shop over a predetermined number of purchases or over a predetermined purchase amount within a predetermined period preset by the purchaser registered as the member through the purchaser terminal.

Preferably, the shopping mall server may display a registration notice window of the impressive shop in the form of a pop-up window on the screen of the purchaser terminal for the purchaser to register the shop as the impressive shop if there exists a favorite shop which satisfies a criterion of the impressive shop when the purchaser confirms product receipt after logging in as the member through the purchaser terminal.

Preferably, in the step (b), the purchaser may write comments in the shopping mall server when registering the shop as the impressive shop in the shopping mall among favorite shops classified in the step (a) through the purchaser terminal.

Preferably, the method may further include, after the step (b), displaying text indicating any one of the “interest shop,” the “purchased shop” and the “impressive shop” on images of the products of the favorite shops registered in the step (a) through the shopping mall server.

Preferably, the method may further include, after the step (b), providing different rewards depending on types of the favorite shops registered in the step (b) from a shopping mall manager or a corresponding seller to the purchaser through the shopping mall server.

Preferably, the method may further include, after the step (b), providing the purchaser with different rewards based on a preset reward standard according to the number of purchases or the purchase amount through the shopping mall server.

According to another aspect of the present invention, there is provided a computer-readable recording medium having a computer-executable program recorded thereon for executing the method.

A method of providing a favorite shop management service in electronic commerce using the Internet according to the present invention can be implemented with codes readable by a computer from a computer-readable recording medium. The computer-readable recording media can include all types of storage devices in which data readable by a computer system is stored.

For example, the computer-readable media may include a read only memory (ROM), a random access memory (RAM), a compact disc ROM (CD-ROM), a magnetic tape, a hard disk, a floppy disk, a portable storage device, a non-volatile memory (flash memory), an optical data storage device, and the like.

According to the method of providing the favorite shop management service in the electronic commerce using the Internet and the computer-readable recording medium recording the program for executing the method described above, it is possible to effectively induce continuous and repeated purchases rather than a one-time purchase by classifying an interest shop, a purchased shop, or an impressive shop as a favorite shop based on the repeated number of purchases or a purchase amount of selling products pre-registered by a seller, and managing the classified favorite shop systematically along with differential rewards.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is an overall block configuration diagram illustrating a system for implementing a method of providing a favorite shop management service in electronic commerce using the Internet according to an exemplary embodiment of the present invention;

FIG. 2 is an overall flowchart illustrating the method of providing the favorite shop management service in the electronic commerce using the Internet according to an exemplary embodiment of the present invention; and

FIGS. 3 to 10 are exemplary screen views illustrating the method of providing the favorite shop management service in the electronic commerce using the Internet according to exemplary embodiments of the present invention.

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention. The embodiments of the present invention are provided to describe the present invention more clearly to those skilled in the art.

First, in the present invention, the term “favorite shop” refers to a shop of a corresponding seller when a purchaser has an interest in a specific selling product, purchases products from the same seller over a predetermine number of purchases preset within a preset period, or purchases products over a preset purchase amount.

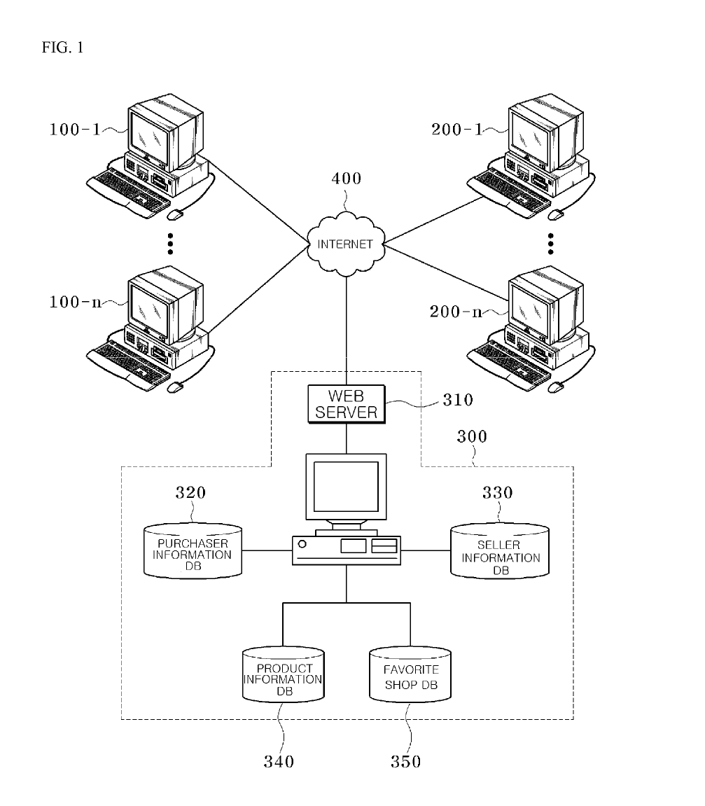

FIG. 1 is an overall block configuration diagram illustrating a system for implementing a method of providing a favorite shop management service in electronic commerce using the Internet according to an exemplary embodiment of the present invention.

Referring to FIG. 1, the overall system for implementing the method of providing the favorite shop management service in the electronic commerce using the Internet according to the exemplary embodiment of the present invention generally includes purchaser terminals 100-1 to 100-n, seller terminals 200-1 to 200-n, an online shopping mall server 300, a web server 310, a purchaser information database (DB) 320, a seller information DB 330, a product information DB 340, a favorite shop DB 350, and the like.

Here, one or more purchaser terminals 100-1 to 100-n and the seller terminals 200-1 to 200-n are connected to an online shopping mall server 300 through the Internet 400.

At this time, the Internet 400 refers to a worldwide open computer network structure for providing various services present in a transmission control protocol (TCP)/Internet protocol (IP) and its higher layers, that is, a hypertext transfer protocol (HTTP), a telnet, a file transfer protocol (FTP), a domain name system (DNS), a simple mail transfer protocol (SMTP), a simple network management protocol (SNMP), a network file service (NFS), a network information service (NIS), and the like. The Internet 400 provides an environment in which an arbitrary purchaser and a seller are enabled to be connected to the online shopping mall server 300 to be described later. On the other hand, the Internet 400 may be the wired or wireless Internet, or a core network integrated with a wired public network, a wireless mobile communication network, or the mobile Internet, or the like.

On the other hand, the purchase terminals 100-1 to 100-n and the seller terminals 200-1 to 200-n, for example, are generally computers such as a desktop personal computer (PC) and a notebook PC, but are not limited thereto. The purchase terminals 100-1 to 100-n and the seller terminals 200-1 to 200-n may be all types of wired/wireless communication devices capable of using a bidirectional electronic commerce service by connecting to the online shopping mall server 300 through the Internet 400.

For example, the purchaser terminals 100-1 to 100-n and the seller terminals 200-1 to 200-n include a portable terminal such as a cellular phone, a personal communications services (PCS) phone, or a synchronous/asynchronous international mobile telecommunication (IMT)-2000 which performs communication through the wireless Internet or mobile Internet. In addition, the purchaser terminals 100-1 to 100-n and the seller terminals 200-1 to 200-n may comprehensively refer to all wired/wireless home appliance/communication devices having user interfaces for accessing the online shopping mall server 300 such as a palm PC, a personal digital assistant (PDA), a smartphone, a wireless application protocol (WAP) phone, and a mobile play station.

The purchaser terminals 100-1 and 100-n may be connected to the online shopping mall server 300 through the Internet 400, and use a marketing relay service of products, services, and the like of the online shopping mall server 300 according to a wired/wireless communication process by a communication interface. The purchaser may perform membership registration as a customer using a service of the online shopping mall server 300 through the purchaser terminals 100-1 to 100-n, and purchaser information in which the purchaser of the membership registration or the like is registered may be stored in the purchaser information DB 320.

In addition, the seller terminals 200-1 to 200-n may be connected to the online shopping mall server 300 through the Internet 400 and use a marketing relay service of products, services, and the like of the online shopping mall server 300 according to a wired/wireless communication process by a communication interface. The seller may perform membership registration as a customer using the service of the online shopping mall server 300 through the seller terminals 200-1 to 200-n and seller information in which the seller of membership registration is registered, product information, and the like may be stored in the seller information DB 330.

Further, the seller terminals 200-1 to 200-n may be connected to the web server 310 of the shopping mall server 300 through the Internet 400 and connected to a specific website provided by the web server 310, for example, Gmarket (http://www.gmarket.co.kr) or the like, to register products desired to be sold by a corresponding seller.

On the other hand, the seller terminals 200-1 to 200-n may register a seller management program (for example, a Gmarket sales manager (GSM) program or the like) (not illustrated) downloaded and installed after membership registration by connecting to the web server 310 of the online shopping mall server 300.

In addition, the online shopping mall server 300, which is a server for relaying product marketing between the seller and the purchaser by operating an online shopping mall through the Internet 400, receives registration of various selling products to be sold by sellers from the seller terminals 200-1 to 200-n through the Internet 400, provides various registered selling products to the purchaser terminals 100-1 to 100-n through the web server 310 connected to the Internet 400, and manages a web page necessary for operating the shopping mall so that selling products necessary for the purchaser may be purchased.

In addition, the online shopping mall server 300 may process payment for a selling product determined to be purchased and selected by the purchaser in a selling product list, perform processing necessary for delivery such as notification related to a paid selling product for the seller, perform processing so that position tracking of the selling product during delivery, a delivery result, and the like are checked, and manage a necessary web page.

The online shopping mall server 300, which is a server for relaying general marketing, an auction, a reverse auction, bargaining, and the like by operating the online shopping mall through the Internet 400, receives registration of various selling products or services or the like to be sold by the sellers from the seller terminals 200-1 to 200-n via the Internet 400 and provides the purchaser terminals 100-1 to 100-n with the selling products, the services, or the like via the Internet 400 so that the purchaser may purchase the selling products or services.

In particular, the online shopping mall server 300 performs a function of classifying each shop having selling products as any one of favorite shops including an interest shop, a purchased shop and an impressive shop based on the number of the purchases or the purchase amount specific to each purchaser registered as a member for pre-registered products from the seller terminals 200-1 to 200-n.

In addition, the online shopping mall server 300 performs a function of transmitting related information to the favorite shop DB 350 so that favorite shops registered through the purchaser terminals 100-1 to 100-n are grouped, stored, and managed as the interest shop, the purchased shop, and the impressive shop specific to each purchase registered as the member.

In addition, the online shopping mall server 300 performs a function of providing a service for generating and displaying a list of selling products along with basic information of the favorite shops registered by purchasers registered as members through the purchaser terminals 100-1 to 100-n on screens of the purchaser terminals 100-1 to 100-n through the web server 310.

The web server 310 mutually connects the purchaser terminals 100-1 to 100-n and the seller terminals 200-1 to 200-n to the online shopping mall server 300 through the Internet 400, and performs a function of providing various web services of the online shopping mall server 300 through a specific web page. The purchaser information DB 320 serves as a DB for recording/managing purchaser information registered by the purchaser registered as the member, that is, a purchaser identifier (ID), a password, contact information, shopping cart information, bidding product information, bid product information, bargaining product information, paid product information, delivery information, purchase determination information, product information about favorite shops, and the like. Relevant information of the purchase information DB 320 may be read by the online shopping mall server 300 or updated to new purchaser information.

The seller information DB 330 serves as a DB for recording/managing seller information (for example, a seller ID, a password, contact information, and the like) to be registered by a seller registered as a member, product information (for example, product names, prices, product brands, product features, and the like of the selling products). Relevant information of the seller information DB 330 may be read by the online shopping mall server 300 or updated to new seller information.

The product information DB 340 serves as a DB recording information about various selling products. Relevant information of the product information DB 340 may be read by the online shopping mall server 300 or updated to new seller information.

The favorite shop DB 350 serves as a DB for receiving information associated with the registered favorite shops from the online shopping mall server 300 through the purchaser terminals 100-1 to 100-n and recording various information about the favorite shops classified as the interest shop, the purchased shop, and the impressive shop specific to each purchaser registered as the member.

Relevant information of the favorite shop DB 350 may be read by the online shopping mall server 300 or updated to new favorite shop information.

The DBs 320 to 350 as described above, for example, may be implemented to be suitable for the objective of the present invention using a relational database management system such as Oracle, Infomix, Sybase, or DB2 or an object-oriented database management system (OODBMS) such as a Gemston, Orion, O2, or the like. The DBs 320 to 350 have proper fields for performing their functions.

Hereinafter, the method of providing the favorite shop management service in the electronic commerce using the Internet according to an exemplary embodiment of the present invention will be described in detail.

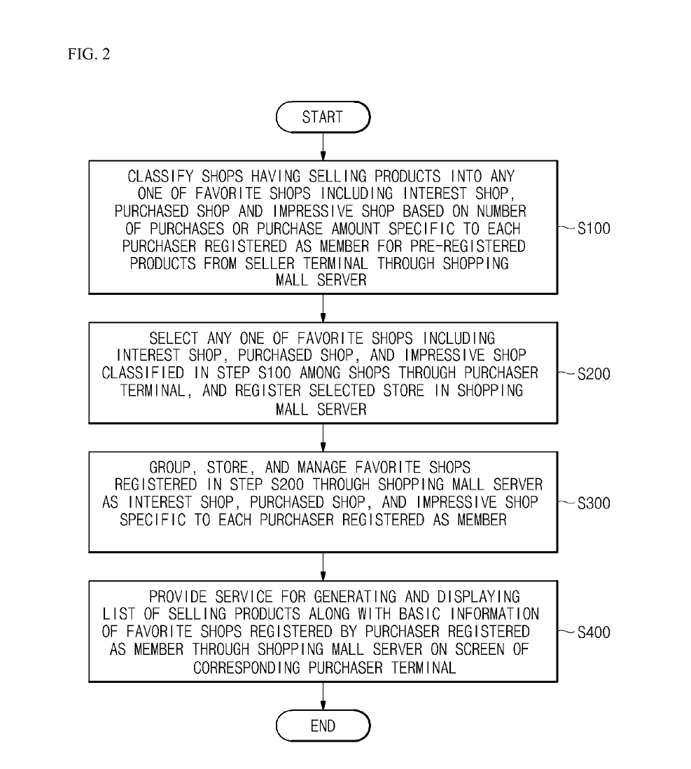

FIG. 2 is an overall flowchart illustrating the method of providing the favorite shop management service in the electronic commerce using the Internet according to the exemplary embodiment of the present invention. FIG. 2 illustrates the case in which the purchase side registers the favorite shop. Unless stated otherwise, the purchaser terminals 100-1 to 100-n are operated as subjects.

Referring to FIGS. 1 and 2, first, the online shopping mall server 300 classifies each shop having selling products as any one of favorite shops including an interest shop, a purchased shop and an impressive shop based on the number of the purchases or the purchase amount specific to each purchaser registered as a member for pre-registered products from the seller terminals 200-1 to 200-n (S 100).

In this case, the interest shop, the purchased shop, and the impressive shop are type of favorite shops. The aforementioned interest store refers to a seller store for selling a product of interest registered by each purchaser registered as the member in a non-purchased state among selling products pre-registered from the seller terminals 200-1 to 200-n. The aforementioned purchased shop refers to the seller's shop selling all products purchased by each purchaser within a preset period (preferably, three years) among pre-registered selling products from the seller terminals 200-1 to 200-n. The aforementioned impressive shop refers to the seller's shop selling products purchased over a preset number of repeated purchases (preferably, three times) or a preset purchase amount (preferably, 300,000 won) within a period preset by each purchaser among selling products pre-registered from the seller terminals 200-1 to 200-n. On the other hand, in step 5100, the online shopping mall server 300 preferably classifies the shop of a corresponding seller as the impressive shop when each purchaser registered as the member through one of the purchaser terminals 100-1 to 100-n purchases products over a preset number of repeated purchases (preferably, three times) or a preset purchase amount (preferably, 300,000 won) within the preset period (preferably, three years).

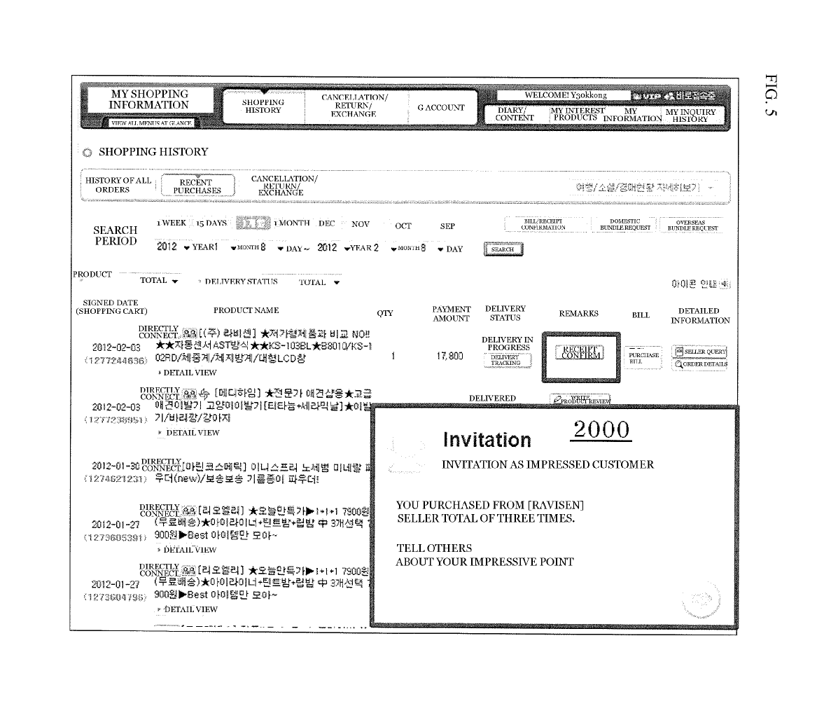

In addition, the online shopping mall server 300 may display a registration notice window 2000 (see FIG. 5) of the impressive shop in the form of a pop-up window on a screen of a corresponding purchaser terminal of the purchaser terminals 100-1 to 100-n to register the shop as the impressive shop if there exists a favorite shop which satisfies a criterion of the impressive shop when the purchaser confirms the product receipt after logging in as the member through the corresponding purchaser terminal of the purchaser terminals 100-1 to 100-n.

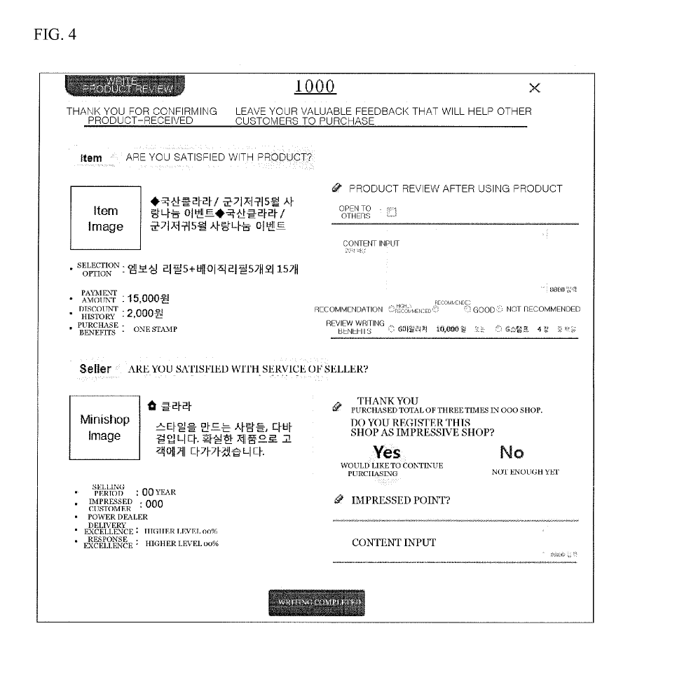

In addition, the online shopping mall server 300 may display a registration confirm window 1000 (see FIG. 4) of the impressive shop in the form of a pop-up window on a screen of a corresponding purchaser terminal of the purchaser terminals 100-1 to 100-n so that the shop of a corresponding seller is registered as the impressive shop if there exists a favorite shop which satisfies a criterion of the above-described impressive shop when the purchaser confirms the receipt of the purchased product after logging in as the member through the corresponding purchase terminal of the purchaser terminals 100-1 to 100-n.

Thereafter, at least any one favorite shop is selected from among the interest shop, the purchased shop, and the impressive shop classified in step S100 through the purchaser terminals 100-1 to 100-n and registered in the shopping mall server 300 (S200).

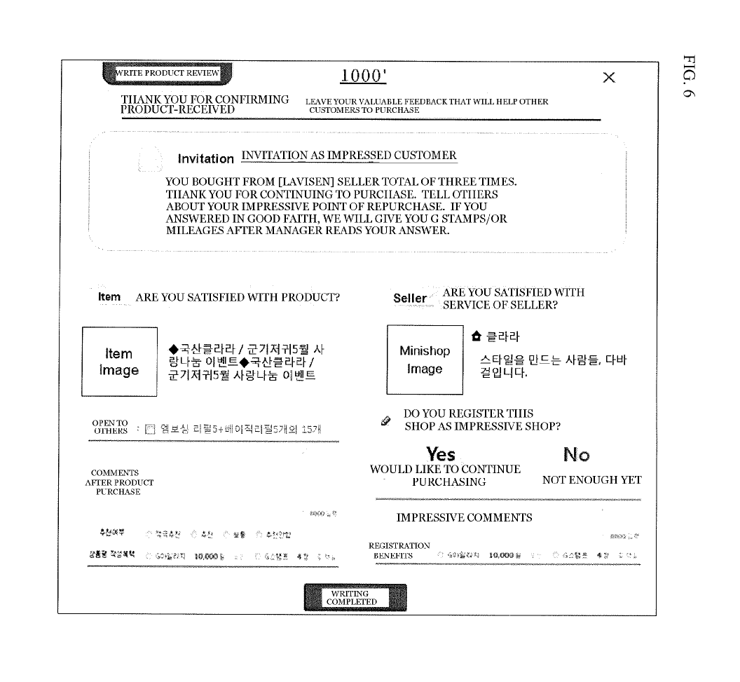

At this time, when the shop is registered as the impressive shop among the favorite shops classified in step S100 through the purchaser terminals 100-1 to 100-n in step S200, it is preferable to register the shop in the shopping mall server 300 along with impressive comments (see FIG. 6).

Thereafter, the online shopping mall server 300 groups, stores, and manages the favorite shops registered in step S200 as the interest shop, the purchased shop, and the impressive shop specific to each purchaser registered as the member while interworking with the favorite shop DB 350 (S300).

Next, the online shopping mall server 300 provides a service for generating and displaying a list of selling products on the screen of the corresponding purchaser terminal of the purchaser terminals 100-1 to 100-n along with basic information of the favorite shop registered by each purchaser registered as the member (S400).

Additionally, the online shopping mall server 300 may further include, after step S200, the step of displaying text indicating any one of the “interest shop,” the “purchased shop,” and the “impressive shop” on a selling product image of the favorite shop registered in step S200.

Further, the online shopping mall server 300 may further include the step of providing, after step S200, providing different rewards depending on types of the favorite shops registered in step 200 from a shopping mall manager or a corresponding seller to the purchaser.

For example, the online shopping mall server 300 provides rewards to the purchaser based on a preset reward standard according to the number of purchases (for example, three/five/ten purchases (setting of a minimum money amount per purchase) or the like) or a purchase amount (capable of being set by the seller (a limit of a minimum money amount). The relevant seller may set a condition for rewards for a regular customer. It is possible to provide a promotional gift at the time of delivery by determining a purchaser as the regular customer when the purchaser repeatedly performs two or three purchases according to the reward standard by the seller.

In addition, the purchaser counts the total accumulated number/amount of purchases or calculates the total accumulated amount of money when he/she repeatedly purchases products from the same seller, thereby storing a count value in a DB. When a purchase condition is satisfied according to the total accumulated number/amount of purchases or the total accumulated amount of money, coupons may be implemented to be downloaded.

On the other hand, coupons may be downloaded after products having low customer transaction are mainly purchased (limited based on a lowest purchase price) as the criterion of the number of purchases. Preferably, the criterion of the number of purchases may be set under a determination by the seller because the criterion of the number of purchases differs according to each group of selling products.

On the other hand, the online shopping mall server 300 may be implemented to construct a systematic mailing mechanism through whether to send the mail when an event/discount by the seller is set and send content of the event/discount of the seller to a target customer (for example, a customer capable of using an event/discount such as a purchasing customer/interest customer).

In addition, when the seller sets an event for a regular customer through a seller management program (for example, a Gmarket GSM program or the like), the online shopping mall server 300 may be implemented to expose the accumulated number of purchases of each purchaser in GSM delivery management and recognize whether the purchaser is a re-purchasing (regular) customer in the actual delivery step.

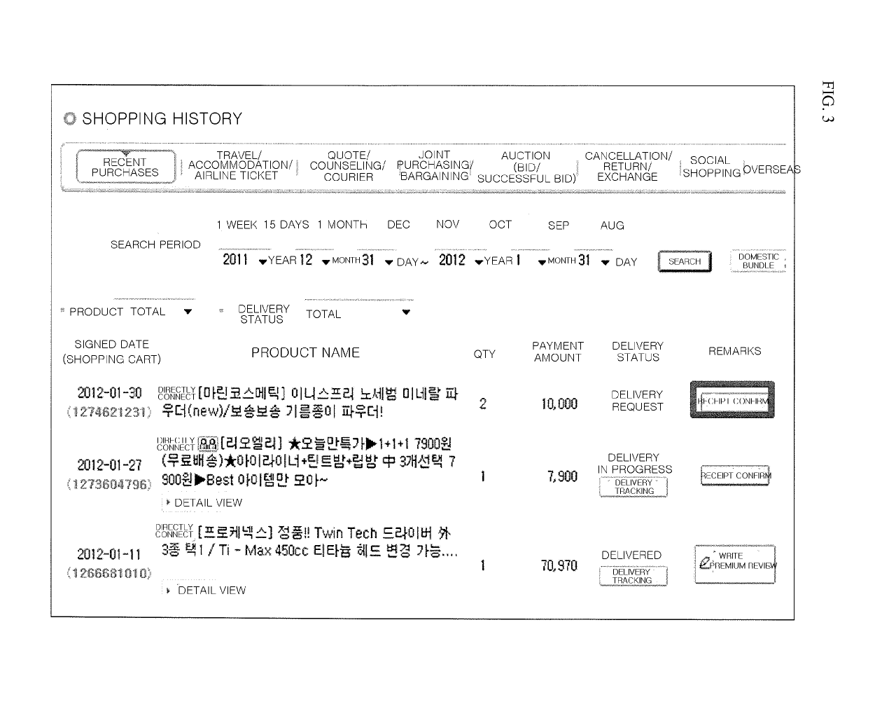

The above-described method of providing the favorite shop management service in the electronic commerce using the Internet according to the exemplary embodiment of the present invention will be specifically described using examples with reference to FIGS. 3 to 10.

FIGS. 3 and 4 are exemplary screen views illustrating the method of providing the favorite shop management service in the electronic commerce using the Internet according to an exemplary embodiment of the present invention. After the purchaser registered as the member logs in to the online shopping mall server 300 through a corresponding purchaser terminal of the purchaser terminals 100-1 to 100-n, a list of recently purchased products is generated and displayed on a screen of the corresponding purchaser terminal of the purchaser terminals 100-1 to 100-n when the purchaser clicks on (selects) a menu item of “Recent Purchases Within Shopping History” among menu items of “My shopping Information” as illustrated in FIG. 3.

Thereafter, when a relevant purchaser selects a “receipt confirm” button of a recently purchased selling product, the online shopping mall server 300 determines whether a relevant shop satisfies a condition of the impressive shop among favorite shops. For example, when the relevant shop satisfies the condition of the impressive shop, a favorite shop registration confirmation window 1000 is displayed in the form of a pop-up window on the corresponding purchaser terminal of the purchaser terminals 100-1 to 100-n as illustrated in FIG. 4.

At this time, the favorite shop registration confirmation window 1000 includes a content input window in which content of impressive comments (or impressive points) may be input along with a selection item of whether to register the shop of a relevant seller as the impressive shop.

FIGS. 5 to 6 are exemplary screen views illustrating the method of providing the favorite shop management service in the electronic commerce using the Internet according to an exemplary embodiment of the present invention. After the purchaser registered as the member logs in to the online shopping mall server 300 through a corresponding purchaser terminal of the purchaser terminals 100-1 to 100-n, a list of recently purchased products is generated and displayed on a screen of the corresponding purchaser terminal of the purchaser terminals 100-1 to 100-n when the purchaser clicks on (selects) a menu item of “Recent Purchases Within Shopping History” among menu items of “My shopping Information” as illustrated in FIG. 5.

Thereafter, when the relevant purchaser selects a “receipt confirm” button of the recently purchased selling product, the online shopping mall server 300 determines whether the relevant shop satisfies a random condition of the impressive shop among the favorite shops. For example, when the relevant shop satisfies the random condition of the impressive shop, an impressive shop registration notice window 2000 is displayed in the form of a pop-up window on a screen of the corresponding purchaser terminal of the purchaser terminals 100-1 to 100-n.

At this time, the random condition of the impressive shop represents a shop of a randomly extracted selling product which satisfies the condition of the impressive shop among selling products of each seller through the online shopping mall server 300.

Then, when the relevant purchaser selects a continue button (for example, an arrow button) provided in the impressive shop registration notice window 2000, an impressive shop registration confirm window 1000′ is displayed in the form of a pop-up window on the screen of the corresponding purchaser terminal of the purchaser terminals 100-1 to 100-n.

At this time, the impressive shop registration confirm window 1000′ includes a content input window in which content of the impressive comments may be input along with a registration selection item of whether to register the shop of the relevant seller as the impressive shop.

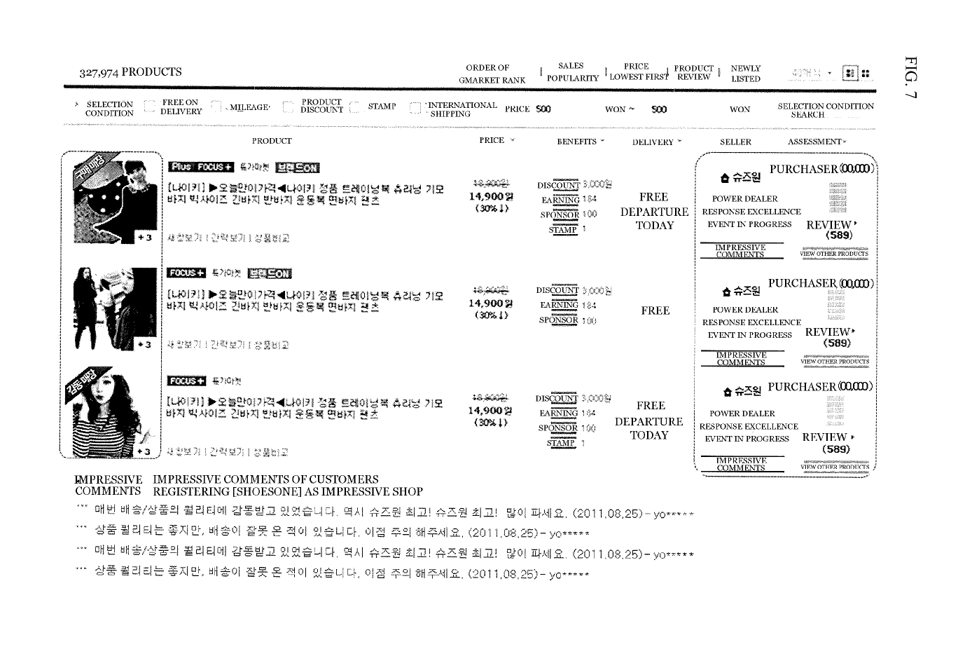

FIG. 7 is an exemplary screen view illustrating the method of providing the favorite shop management service in the electronic commerce using the Internet according to an exemplary embodiment of the present invention. After the purchaser registered as the member logs in to the online shopping mall server 300 through a corresponding purchaser terminal of the purchaser terminals 100-1 to 100-n, a list of impressive comments as well as basic information of a favorite shop (for example, a purchased shop, an impressive shop, or the like) is generated along with brief information of selling products of the shop registered as the favorite shop by the purchaser and displayed on the screen of the corresponding purchaser terminal of the purchaser terminals 100-1 to 100-n.

At this time, it is preferable that the online shopping mall server 300 provide a service for displaying text indicating any one of the interest shop, the purchased shop and the impressive shop on images of the products of the favorite shops.

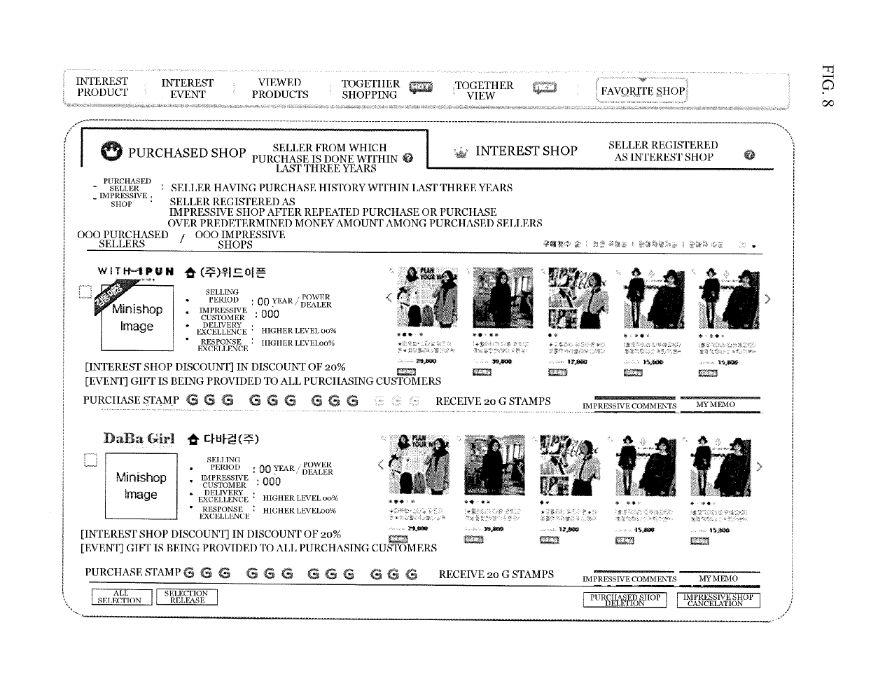

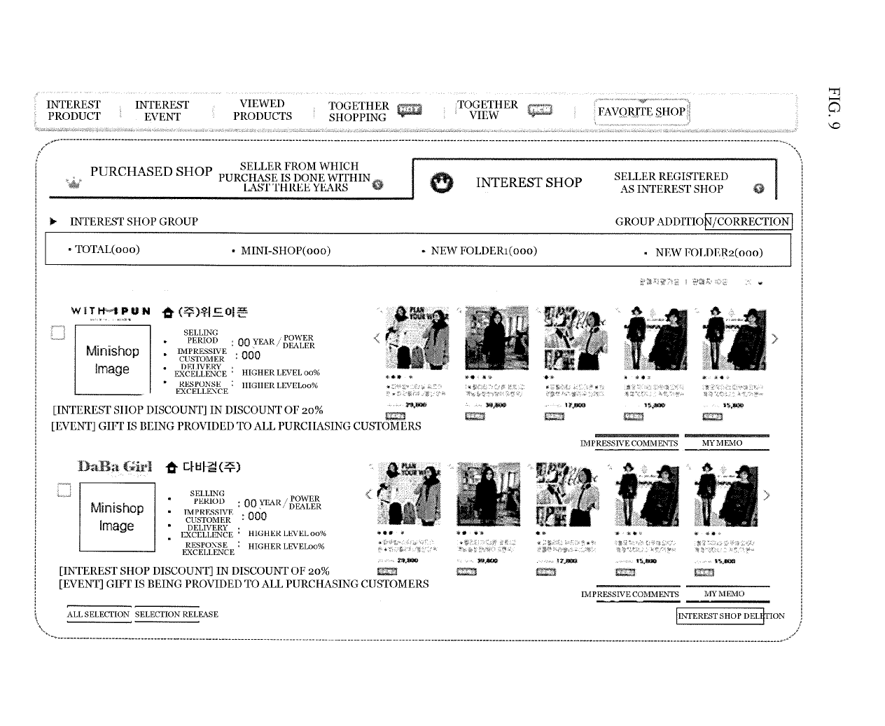

FIGS. 8 to 9 are exemplary screen views illustrating the method of providing the favorite shop management service in the electronic commerce using the Internet according to an exemplary embodiment of the present invention. When the purchaser selects a menu item “Favorite Shop (Purchased Shop) Of My Interest Product” among menu items of “My Page” after the purchaser registered as the member logs in to the online shopping mall server 300 through a corresponding purchaser terminal of the purchaser terminals 100-1 to 100-n, a list of relevant selling products purchased within last three years is generated along with shop information of sellers thereof and displayed on the corresponding purchaser terminal of the purchaser terminals 100-1 to 100-n as illustrated in FIG. 8.

On the other hand, when the relevant purchaser selects the menu item “Favorite Shop (Purchased Shop) Of My Interest Product,” a list of relevant selling products is generated along with shop information of sellers registered by the relevant purchaser and displayed on the screen of the corresponding purchaser terminal of the purchaser terminals 100-1 to 100-n.

At this time, the shop information of the seller registered as the purchased shop or the impressive shop, for example, may include a shop name, a shop image, a product image, rewards (purchase stamps), the number of retained impressed customers, discount/event, impressive comments, and the like.

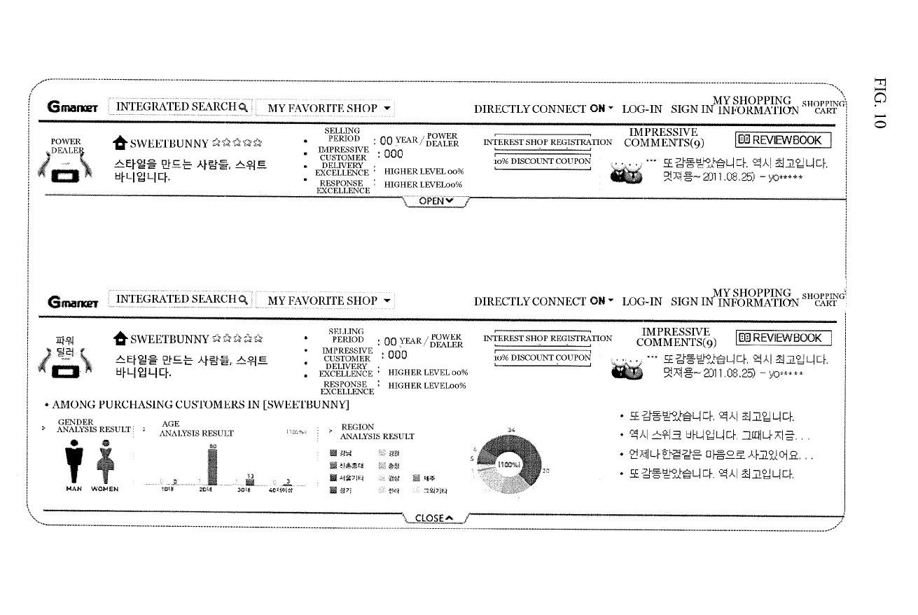

FIG. 10 is an exemplary screen view illustrating the method of providing the favorite shop management service in the electronic commerce using the Internet according to an exemplary embodiment of the present invention. After the purchaser registered as the member logs in to the online shopping mall server 300 through a corresponding purchaser terminal of the purchaser terminals 100-1 to 100-n, a list of mini-shop information of the sellers registered as my favorite shops by the corresponding purchaser is generated and displayed on the screen of the corresponding purchaser terminal of the purchaser terminals 100-1 to 100-n when the corresponding purchaser finds a menu of “My Favorite Shops” through an “integrated search.”

At this time, the mini-shop information of the sellers registered as my favorite shops described above, for example, may include information of a shop name, the number of retained impressed customers, a discount/event, impressive comments, and purchasing customer analysis (for example, a gender analysis result, an age analysis result, a region analysis result, and the like)

On the other hand, a method of providing a favorite shop management service in electronic commerce using the Internet according to the exemplary embodiment of the present invention can be implemented with codes readable by a computer from a computer-readable recording medium. The computer-readable recording media can include all types of storage devices in which data readable by a computer system is stored.

For example, the computer-readable media may include a ROM, a RAM, a CD-ROM, a magnetic tape, a hard disk, a floppy disk, a portable storage device, a non-volatile memory (flash memory), an optical data storage device, and the like.

Further, the computer-readable media are distributed among computer systems connected through a computer communication network, and can be stored as codes readable in a distribution type to be executed.

Although the preferred embodiments of the method of providing the favorite shop management service in the electronic commerce using the Internet and a computer-readable recording medium recording a program for executing the method have been described, the present invention is not limited thereto. It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. An electronic commerce method of brokering an on-line transaction between a seller and a purchaser in an on-line shopping mall through a seller terminal and a purchaser terminal which are connected to a shopping mall server via the internet, comprising:
(a) classifying each shop having selling products as any one of favorite shops including an interest shop, a purchased shop and an impressive shop based on the number of the purchases or the purchase amount specific to each purchaser registered as a member for pre-registered products from the seller terminal through the shopping mall server;
(b) selecting any one of the favorite shops including the interest shop, the purchased shop and the impressive shop classified in the step (a) through the purchaser terminal, and registering the selected shop in the shopping mall server;
(c) grouping, storing, and managing the favorite shops as the interest shop, the purchased shop and the impressive shop specific to each purchaser registered as the member; and
(d) providing a service for displaying a list of selling products along with basic information of the favorite shops registered by the purchaser registered as the member through the shopping mall server on a screen of the purchaser terminal

2. The method of claim 1, wherein in the step (a), the shopping mall server may designate a shop as the impressive shop if the purchaser purchases products from the same shop over a predetermined number of purchases or over a predetermined purchase amount within a predetermined period preset by the purchaser registered as the member through the purchaser terminal.

3. The method of claim 2, wherein the shopping mall server displays a registration notice window of the impressive shop in the form of pop-up window on screen of the purchaser terminal for the purchaser to register the shop as the impressive shop if there exists a favorite shop which satisfy criterion of the impressive shop when the purchaser logs in as a member through the purchaser terminal.

4. The method of claim 2, wherein the shopping mall server displays a registration notice window of the impressive shop in the form of pop-up window on screen of the purchaser terminal for the purchaser to register the shop as the impressive shop if there exists a favorite shop which satisfy criterion of the impressive shop when the purchaser confirms the receipt of the products after logging in as a member through the purchaser terminal.

5. The method of claim 1, wherein in the step (b), the purchaser may write comments in the shopping mall server when registering the shop as the impressive shop in the shopping mall among favorite shops classified in the step (a) through the purchaser terminal.

6. The method of claim 1, further comprising, after the step (b), displaying text indicating any one of the “interest shop,” the “purchased shop” and the “impressive shop” on images of the products of the favorite shops registered in the step (a) through the shopping mall server.

7. The method of claim 1, further comprising, after the step (b), providing different rewards depending on types of the favorite shops registered in the step (b) from a shopping mall manager or a corresponding seller to the purchaser through the shopping mall server.

8. The method of claim 1, further comprising, after the step (b), providing the purchaser with different rewards based on a preset reward standard according to the number of purchases or the purchase amount through the shopping mall server.

9. A computer-readable recording medium having a computer-executable program recorded thereon for executing the method according to any one of claims 1 to 8.
